(19) United States
(12) Patent Application Publication
(10) Pub. No.: US 2026/0225053 A1
(43) Pub. Date: Aug. 6, 2026

(54) MICRO-STATIC MIXER FOR MIXING TWO FLUIDS

(71) Applicant: NORITAKE CO., LIMITED, Nagoya-shi, Aichi (JP)

(72) Inventors: Kazuaki KUMAGAI, Nagoya-shi (JP); Tomoki FUKAGAWA, Nagoya-shi (JP)

(73) Assignee: NORITAKE CO., LIMITED, Nagoya-shi, Aichi (JP)

(21) Appl. No.: 19/157,228

(22) PCT Filed: Dec. 7, 2023
(86) PCT No.: PCT/JP2023/043919

§ 371 Date: Aug. 15, 2025

(30) Foreign Application Priority Data
Feb. 27, 2023 (JP) 2023-028959

(51) Int. Cl. B01F 25/431; B01F 33/30; B01F 35/50; B01F 101/00

(52) U.S. Cl. CPC B01F 25/4317; B01F 25/4312; B01F 33/30; B01F 35/514; B01F 2101/2204; B01F 2215/0422

(57) ABSTRACT

Provided is a micro-static mixer for mixing two components, the micro-static mixer having few components, being small in size, and eliminating the possibility of leakage of a liquid mixture or the like.

The micro-static mixer comprises a first passage 38 that connects a first connection part 20 and a third connection part 24, a second passage 40 that branches from the first passage 38 and opens at a second end surface 14, and a long mixing element 42 that is accommodated within the first passage 38, the long mixing element 42 being positioned adjacent to a third tube 34 connected by a third joint 36 that is connected to the third connection part 24. As a result, the long mixing element 42 is accommodated within the linearly formed first passage 38, can be configured so that a main body 18 is integrally formed with a thick-walled portion thereof, and has high rigidity, making it possible for the long mixing element 42 to be extracted during cleaning; thus, high cleansing performance is achieved, the possibility of leakage of a liquid mixture (third liquid F12) is eliminated, the number of components in the mixer 10 becomes fewer, and the framework thereof decreases in size.

The present invention relates to a micro-static mixer for mixing two fluids, which is compatible with minute flow rates, and in particular to a micro-static mixer for mixing two fluids, which has excellent washability and which enables removable of a mixing element that becomes more fragile as its diameter becomes smaller.

### BACKGROUND ART

There is known a static mixer for mixing two fluids, which has an elongated mixing element with a constat outside diameter, a thin-walled cylindrical body with a constant inside diameter that houses the elongated mixing element, and a joint that fixes the cylindrical body to a main body, such that an end portion of the cylindrical body is fluid-tight with respect to a fluid delivery tube. For example, Patent Document 1 discloses such a static mixer.

In such a static mixer for mixing two fluids, the cylindrical body is fluid-tightly fixed to the fluid delivery tube by tightening the joint, but the tightening of the joint causes plastic deformation of the cylindrical body, thereby making it impossible to remove the mixing element and making it impossible to sufficiently clean the mixing element and the cylindrical body housing the mixing element. For example, in the field of fluid chromatography, which analyzes trace components in fluid samples, it is desirable to sufficiently clean the mixing element of the static mixer and the cylindrical body housing the static mixer, but there is a problem that the mixing element could be damaged when they are to be cleaned. In particular, in the micro-static mixers, which use the small-diameter mixing element to obtain small amount of mixed fluid for testing or research, for example, the smaller the diameter of the mixing element, the thinner a wall thickness of the mixing element becomes and the smaller a cross-sectional area connecting right-handed and left-handed twisted portions becomes, thereby making the mixing element more fragile, and this inconvenience is particularly noticeable.

On the other hand, as disclosed in Patent Document 2, there is proposed a static mixer for mixing two fluids in which the cylindrical body housing the mixing element is replaced by a main body that is to be dividable into first and second plates, and a cylindrical-shaped mixing chamber that houses the mixing element is provided in a divided surface of each of the first and second plates, such that a center line of the mixing chamber lies on the divided surface, and such that the first and second plates are fastened to each other with a spacer being provided between the first and second plates.

### PRIOR ART DOCUMENTS

### Patent Documents

### Patent Document 1

Japanese Unexamined Patent Application Publication No. 2017-136558

### Patent Document 2

Japanese Unexamined Patent Application Publication No. 2022-063804

### SUMMARY OF THE INVENTION

### Object to be Achieved by the Invention

In the micro-static mixer disclosed in Patent Document 2, by releasing the mutual fastening between the first and second plates, the mixing element is exposed on one of grooves constituting the mixing chamber, and then the mixing element and the mixing chamber can be cleaned. After cleaning, the mixing element is placed in either the groove formed in the first plate or the groove formed in the second plate, and then the first and the seconds plates are fastened to each other with the spacer provided between, thereby preventing damage to the mixing element.

However, the above-described conventional micro-static mixer is merely configured to further mix a mixed fluid supplied from a mixer that merges a plurality of kinds of fluids in a predetermined ratio. Thus, the conventional micro-static mixer requires a certain amount of fluid volume to mix the two fluids. Further, since the main body of the micro-static mixer is composed of the first and second plates and the spacer provided therebetween, mating surfaces of the first and second plates and the spacer extend through the mixing chamber, thereby providing possibility of leakage of the mixed fluid, and there is a problem that the static mixer requires a large number of components and a large-sized structure body.

The present invention was made in view of the background discussed above. It is therefore an object of the present invention to provide a micro-static mixer for mixing two fluids, which is small in size with a small number of components, and which is free of possibility of fluid leakage.

### Measures for Solving the Problem

In order to achieve the above-described object, the gist of the present invention is that, in (a) a micro-static mixer for mixing two fluids, which includes: a main body having a first end surface, a second end surface and a third end surface such that the first and third end surfaces are opposed to each other; a first joint screwed in a first connection portion of the first end surface; a second joint screwed in a second connection portion of the second end surface; a third joint screwed in a third connection portion of the third end surface; a first tube connected to the first joint, such that a first fluid is to be inputted through the first tube; a second tube connected to the second joint, such that a second fluid is to be inputted through the second tube; and a third tube connected to the third joint, such that a third fluid that is a mixture of the first and second fluids is to be outputted through the third tube, the micro-static mixer includes: (b) a first passage provided in the main body and extending straightly to connect between the first connection portion and the third connection portion; (c) a second passage provided in the main body and branching from the first passage to open in the second end surface; and (d) an elongated mixing element housed in the first passage, (e) wherein the elongated mixing element is positioned in contact with the third tube that is connected to the third joint screwed in the third connection portion.

### Effects of the Invention

In the micro-static mixer for mixing two fluids, which is constructed as described above, the first passage is provided in the main body to extend straightly between the first connection portion and the third connection portion, the second passage is provided in the main body to branch from the first passage to open in the second end surface, and the elongated mixing element is housed in the first passage and is positioned in contact with the third tube that is connected to the third joint screwed in the third connection portion. Thus, the elongated mixing element is housed in the first passage extending in a straight line, and is located in the main body which is a thick, integral structure with high rigidity, and can be removed when it is to be cleaned, resulting in a high washability. Further, since the main body can be constructed as an integral unit, there is no possibility of leakage of the mixed fluid, the number of components of the micro-static mixer is reduced, and the structure body is small. Further, since the elongated mixing element is positioned by being in contact with the third tube connected to the third joint fixed to the third connection portion, there is no need to provide a stopper to prevent movement of the mixing element having a relatively small diameter, which provides an advantage that, when the elongated mixing element is to be cleaned, the elongated mixing element can be removed without interference.

Preferably, an upstream-side end portion of the mixing element is located in the junction of the first and second passages. Thus, the first fluid introduced by the first passage and the second fluid introduced by the second passage are joined with each other, and start to be mixed to each other by the mixing element immediately after joining, so that a mixing performance can be achieved even with minute flow rates. In particular, when the first fluid and the second fluid have property of reacting with each other to generate by-products, if there is a distance from the junction of the first and second passages to the mixing element, the by-products are generated during that time, so that, even if mixing by the mixing element starts after that, it is difficult to obtain a sufficient mixing performance. This kind of inconvenience is more noticeable the smaller the flow rates of the first and second fluids. However, if mixing by the mixing element starts immediately after the first fluid and the second fluid join with each other, the mixing by the mixing element starts before the by-products are generated, so that a high mixing performance can be obtained.

Preferably, an upstream end of the mixing element is located on an upstream side of a junction point at which the second fluid having passed through the second passage is caused to join with the first fluid passing through the first passage. Thus, as compared with a case in which the upstream end of the mixing element is located on a downstream side of the junction point, a high mixing performance can be obtained even when the total flow rate is as low as 1 mL/min or less.

Preferably, the main body is constituted by a transparent thick plate-shaped member. Thus, a mixing state of the first and second fluids can be visually observed. Further, because the main body is constructed as a single unit, there is no possibility of leakage of the mixed fluid, and a number of components required to constitute the micro-static mixer is reduced, so that the structure body is smaller.

Preferably, the elongated mixing element is constituted by a belt-shaped member, and includes clockwise twisted portions and counterclockwise twisted portions that are alternately arranged in an axial direction of the elongated mixing element, such that the belt-shaped member is twisted clockwise by 180 degrees around an axis of the elongated mixing element in each of the clockwise twisted portions, such that the belt-shaped member is twisted counterclockwise by 180 degrees around the axis in each of the counterclockwise twisted portions, and such that a linear edge constituted by an end of each of the clockwise twisted portions in the axial direction is perpendicular to a linear edge constituted by an end of each of the counterclockwise twisted portions in the axial direction, which is adjacent to the linear edge constituted by the end of each of the clockwise twisted portions in the axial direction. Thus, the first and second fluids having joined with each other in the first passage are efficiently mixed with each other by the elongated mixing element housed in the first passage.

Preferably, the third tube, which is connected to the third joint screwed in the third connection portion, is reduced in diameter by the third joint, and the elongated mixing element is positioned in contact with an end face of the third tube that is reduced in the diameter. Thus, it is not necessary to provide, in the main body, a stopper for positioning the mixing element, and it is possible to increase a degree of freedom to remove the mixing element when the mixing element is to be cleaned.

In the mixing element, the clockwise twisted portions and the counterclockwise twisted portions may be integrally provided and alternately arranged. However, the mixing element may have any one of various configurations that is configured to mix the fluids flowing in a mixing chamber, such as an element with a series of twisted portions twisted only in one direction, either clockwise or counterclockwise, or a mixing element with a plurality of mixing blades arranged radially. The mixing element may be provided in the mixing chamber such that the mixing element is rotatable about its axis and is movable in the axial direction. Further, the mixing element may also be provided the mixing chamber such that the mixing element is unrotatable about its axis and is unmovable in the axial direction owing to a stopper or the like. Various types of fluids are suitable as the fluids to be mixed, and fluids may be other than liquids.

The present invention is applicable to small static mixers for mixing two fluids, preferably using a small mixing element with an outside diameter of 2 mm or less, or even 1 mm or less, and with a clearance between the mixing element and a cylindrical inner circumferential surface of the mixing chamber of 0.05 mm or less, or even 0.03 mm or less, for obtaining a small amount of mixed fluid for testing or research, or for mixing and reacting small amounts of fluids. However, the present invention is applicable also to a static mixer using a mixing element with an outside diameter larger than 2 mm, or a static mixer with a clearance between the mixing element and a cylindrical inner circumferential surface of the mixing chamber of 0.05 mm or more.

### BRIEF DESCRIPTION OF DRAWINGS

FIG. 1 A front view showing a static mixer that is an embodiment of the present invention.

FIG. 2 A view for explaining a mixing element housed in a first passage provided in a main body of the static mixer of FIG. 1.

FIG. 3 A perspective view for explaining a joint screwed in a connection portion of the main body of the static mixer of FIG. 1.

FIG. 4 A view for explaining a state in which the joint of FIG. 3 is screwed in the second connection portion of the main body of the static mixer of FIG. 1.

FIG. 5 A view for explaining a position of an upstream end of the mixing element housed in the first passage provided in the main body that is shown in FIG. 1, and showing a case in which the upstream end of the mixing element is located on an upstream side of a junction point.

FIG. 6 A view for explaining a conventional static mixer for mixing two fluids.

FIG. 7 A diagram for explaining a mixing performance of the static mixer of FIG. 1 in comparison with that of the conventional mixer of FIG. 6.

FIG. 8 A view corresponding to FIG. 5, which is for explaining a main part of a mixer of another embodiment of the present invention, wherein the upstream end of the mixing element is located on a downstream side of the junction point.

FIG. 9 A diagram for explaining the mixing performance of the static mixer of the second embodiment in which a position of the mixing element is different from that in the static mixer in FIG. 1.

### MODE FOR CARRYING OUT THE INVENTION

Hereinafter, there will be described an embodiment of the present invention, in detail with reference to the drawings. It is noted that figures of the drawings are simplified or deformed as needed, and each portion is not necessarily precisely depicted in terms of dimension ratio, shape, etc.

### First Embodiment

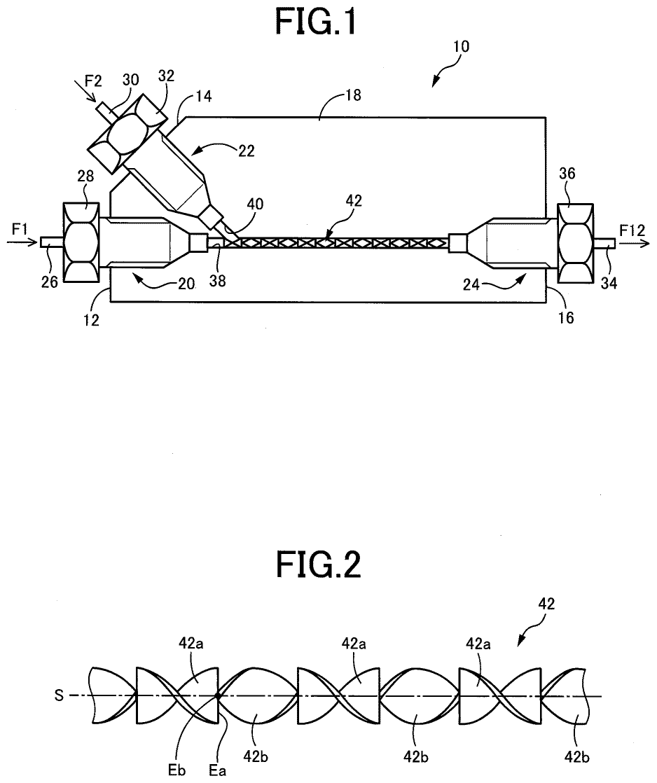

FIG. 1 is a front view showing a micro-static mixer (hereinafter referred to as “mixer”) 10 for mixing two fluids, which is an embodiment of the present invention. The mixer 10 includes a main body 18 having a first end surface 12, a second end surface 14 and a third end surface 16. The main body 18 is constituted by a block-shaped, i.e., thick plate-shaped member. The first end surface 12 and the third end surface 16 are a pair of surfaces which are opposed and parallel to each other. The second end surface 14 is adjacent to the first end surface 12 and is inclined with respect to the first end surface 12.

The main body 18 is constituted by a transparent resin and has high rigidity, and the transparent resin is made of acrylic resin, for example. However, the main body 18 does not necessarily have to be constituted by a transparent member, and may be constituted by a thick plate-shaped untransparent metal member.

The first end surface 12, second end surface 14 and third end surface 16 of the main body 18 are provided with a first connection portion 20, a second connection portion 22 and a third connection portion 24, respectively. The first connection portion 20, second connection portion 22 and third connection portion 24 each having a circular hole shape are formed so as to open in the first end surface 12, second end surface 14 and third end surface 16, respectively. A first joint 28 is screwed in the first connection portion 20 of the first end surface 12, and a first tube 26 is connected to the first joint 28, such that a first fluid is to be inputted through the first tube 26. A second joint 32 is screwed in the second connection portion 22 of the second end surface 14, and a second tube 30 is connected to the second joint 32, such that a second fluid is to be inputted through the second tube 30. A third joint 36 is screwed in the third connection portion 24 of the third end surface 16, and a third tube 34 is connected to the third joint 36, such that a third fluid that is a mixture of the first and second fluids is to be outputted through the third tube 34. Each of the first tube 26, second tube 30 and third tube 34 is a soft pipe made of synthetic resin or metal, for example, with an inside diameter of about 1 mm. Each of the first joint 28, second joint 32 and third joint 36 is made of synthetic resin, for example, and is provided to fasten a corresponding one of the first tube 26, second tube 30 and third tube 34.

In the main body 18, a first passage 38 is provided to extend straightly and open into the first connection portion 20 and the third connection portion 24, so as to connect between the first connection portion 20 and the third connection portion 24. Further, in the main body 18, a second passage 40 is provided to branch obliquely from the first passage 38 and open in the second connection portion 22 that opens in the second end surface 14. The second passage 40 has the same inside diameter as the first passage 38, for example, an inside diameter of 1 mm. In the main body 18, the first fluid F1 introduced by the first passage 38 and the second fluid F2 introduced by the second passage 40 are joined and mixed by a mixing element 42. In order to obtain sufficient rigidity, the main body 18 is made to have a thickness of, for example, 5 to 20 times, preferably 8 to 15 times, as large as the diameter of the first passage 38.

In the first passage 38 provided to extend straightly in the main body 18, the elongated mixing element 42, which is shown by way of example in FIG. 2, is housed such that the mixing element 42 is coaxial with the first passage 38. The mixing element 42 is constituted by a belt-shaped member, and includes clockwise twisted portions 42a and counterclockwise twisted portions 42b that are alternately arranged in a direction an axis S of the mixing element 42. In each of the clockwise twisted portions 42a, the belt-shaped member is twisted clockwise by 180 degrees around the axis S of the elongated mixing element 42. In each of the counterclockwise twisted portions 42b, the belt-shaped member is twisted counterclockwise by 180 degrees around the axis S of the elongated mixing element 42. A linear edge Ea constituted by an end of each of the clockwise twisted portions 42a in the direction of the axis S is perpendicular to a linear edge Eb constituted by an end of each of the counterclockwise twisted portions 42b in the direction of the axis S, wherein the linear edge Ea and the linear edge Eb are adjacent to each other in the direction of the axis S. That is, the clockwise twisted portions 42a and the counterclockwise twisted portions 42b are provided in equal numbers and alternately with a phase shift of 900 around the axis S.

The mixing element 42 preferably has the same number of clockwise twisted portions 42a and counterclockwise twisted portions 42b arranged alternately, so that a clockwise torque and a counterclockwise torque applied to the mixing element 42 by the fluid flowing in the first passage 38 are substantially the same as each other, and rotation of the mixing element 42 is suppressed without providing a rotation stopper or the like. Further, since the clockwise twisted portions 42a and the counterclockwise twisted portions 42b are arranged alternately even if they are not provided in the same number, the larger the number, the smaller a difference between the clockwise torque and the counterclockwise torque applied to the mixing element 42 by the fluid flowing in the first passage 38, so that the more the rotation of the mixing element 42 is suppressed.

As described above, since the mixing element 42 is provided in the first passage 38, a space within the first passage 38 serves as a mixing chamber for mixing the first fluid F1 and the second fluid F2. When the first fluid F1 and the second fluid F2 are caused to flow along twisting of the mixing element 42, they are mixed by repeatedly dividing, merging, turning clockwise and turning counterclockwise by the clockwise twisted portions 42a and the counterclockwise twisted portions 42b that are out of phase with each other by 900 around the axis S. The static mixer 10 of this embodiment is for mixing small amounts of fluid, such as liquid, for example, for testing or research, and the outside diameter φ of the mixing element 42 is, for example, about 1 mm, and a clearance C between the mixing element 42 and an inner circumferential surface of the first passage (mixing chamber) 38 that houses the mixing element 42 is 0.03 to 0.05 mm.

The mixing element 42 of the present embodiment is manufactured from metal materials such as stainless steel, inorganic materials such as ceramics, or synthetic resin materials, for example, by laser beam machining, electron beam machining, electric discharge machining or 3D printing. The clockwise twisted portions 42a and counterclockwise twisted portions 42b of the mixing element 42 are connected through small areas approximately equal to their thickness, so that they have a relatively fragile nature and are easily damaged by slight external forces.

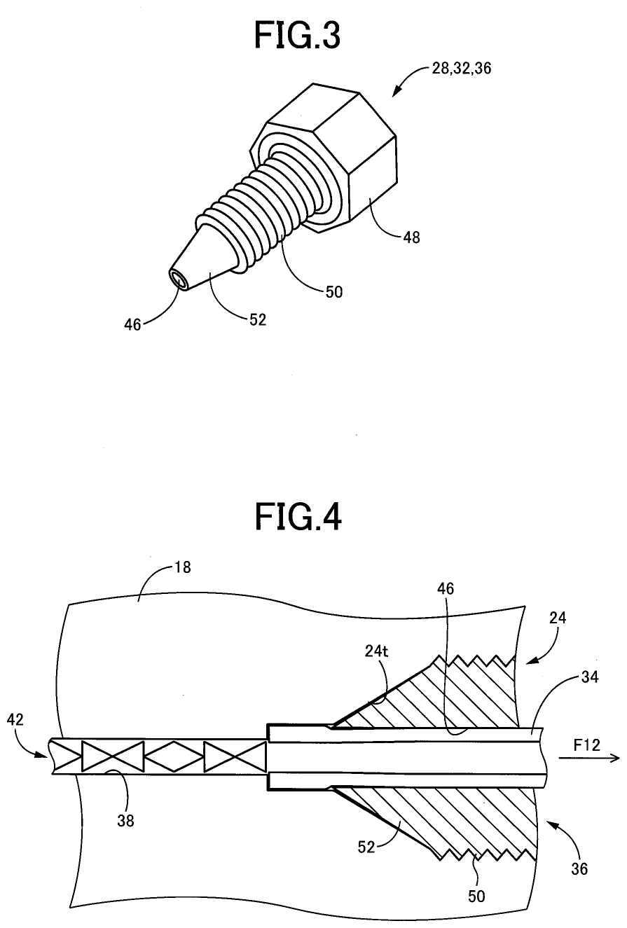

The first, second and third joints 28, 32, 36 have the same shape as shown in a perspective view of FIG. 3. Each of the first, second and third joints 28, 32, 36 has a center hole 46 through which a corresponding one of the first, second and third tubes 26, 30, 34 is to be inserted, a hexagonal operating portion 48 to which a rotational operating force is to be applied, an external thread portion 50 protruding from the operating portion 48 and a tapered portion 52 provided on a distal end side of the external thread portion 50.

FIG. 4 is a cross sectional view showing, in enlargement, a state in which the third joint 36, to which the third tube 34 is connected, is screwed in the third connection portion 24. As shown in FIG. 4, when the third joint 36 is tightened, the third tube 34, which has the inside diameter similar to the outside diameter of the mixing element 42, for example, a diameter of about 1 mm, is pressed against a tapered inner circumferential surface 24t provided in the third connection portion 24, so that a distal end portion of the tapered portion 52 is reduced in diameter, whereby an end portion of the third tube 34 is deformed in a direction of reduction in diameter, and an end face of the third tube 34 is slightly deformed to be reduced in diameter. A downstream end of the mixing element 42, which has a diameter of about 1 mm, is brought into contact with the end face of the third tube 34 whose diameter is reduced, and the elongated mixing element 42 is positioned in the first passage 38.

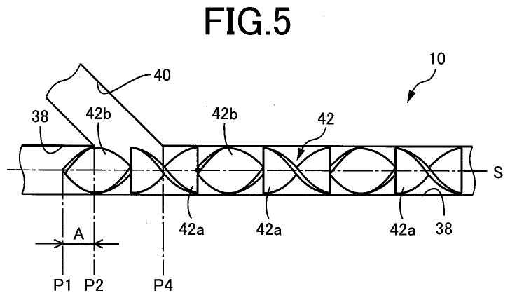

In the mixing element 42 that is positioned as described above, as shown in FIG. 5, the second passage 40 meets with the first passage 38 in a portion of the first passage 38 in which an upstream-side end portion of the mixing element 42 is located. That is, the upstream-side end portion of the mixing element 42 is located in a junction of the first and second passages 38, 40. The junction is between a most upstream-side end P2 and a most downstream-side end P4 of an opening of the second passage 40 in the direction of the axis S, wherein the opening of the second passage 40 is an opening that opens in the first passage 38. More specifically, an upstream end P1 of the mixing element 42 is located on an upstream side of a junction point in the direction of the axis S by a distance A that is about a half of a length of each of the clockwise twisted portions 42a or counterclockwise twisted portions 42b. The junction point, at which the second fluid F2 having passed through the second passage 40 is caused to join with the first fluid F1 passing through the first passage 38, corresponds to the most upstream-side end P2 of the above-described opening of the second passage 40 that opens in the first passage 38. In this way, where the upstream-side end portion of the mixing element 42 is located within the junction, particularly, where the upstream end P1 of the mixing element 42 is located on the upstream side of the junction point P2, a high mixing performance can be obtained, as described later, particularly, in mixing at an extremely low total flow rate of 5 mL/min or less.

When the mixer 10 constructed as describe above is to be washed, the first joint 28 connecting the first tube 26 is removed from the first connection portion 20, the second joint 32 connecting the second tube 30 is removed from the second connection portion 22, and the third joint 36 connecting the third tube 34 is removed from the third connection portion 24. In this state, since the first passage 38 extends straightly, the mixing element 42 extending straightly can be easily removed from the first passage 38, so that a high washability is obtained. After washing, the straightly extending mixing element 42 can be easily inserted into the straightly extending first passage 38.

### Experimental Example 1

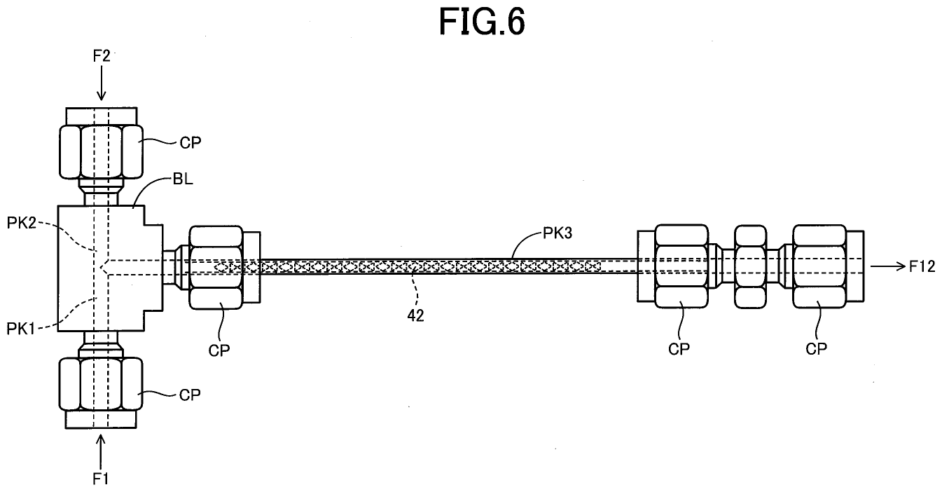

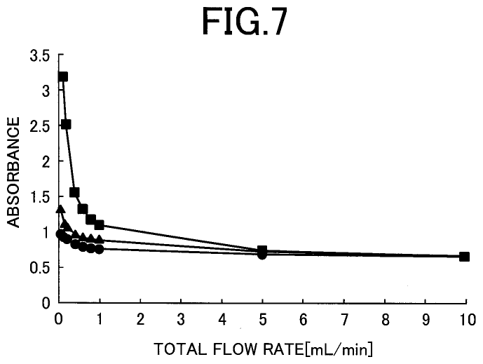

In Experimental Example 1, the present inventors used the mixer 10 shown in FIG. 1 and the conventional two-fluid mixing mixer shown in FIG. 6, and measured an absorbance corresponding to their mixing performance based on Dushman reaction for a total flow rate ranging from 0.05 to 10 mL/min under the following mixing test condition. FIG. 7 shows the measured values. In the Dushman reaction, reactions of formulas (1) and (2) compete with each other, but the reaction of formula (1) is faster. Therefore, the faster the competition, the less I3—is produced in the reaction of formula (3), and the mixing performance can be evaluated from the absorbance of I3—. That is, the lower the absorbance of I3—, the higher the mixing performance. In formulas (1), (2), and (3), K1, K2, and K3 are equilibrium constants, and k1, k2, and k3 are reaction rate constants. The first fluid F1 and the second fluid F2 used in the following mixing test condition have property (physical property) of producing by-products (for example, I3—in formula (3)) through their mutual reaction.

$$\begin{matrix}[ Mathematical Formulas 1 ] & \\ {H}_{2} {BO}_{3}^{-} + {H}^{+} {{⇄}_{{k}_{- 1}}}^{{k}_{1}} {H}_{3} {BO}_{3} {K}_{1} = \frac{{k}_{- 1}}{{k}_{1}} & ( 1 )\end{matrix}$$

$$5 {I}^{-} + {IO}_{3}^{-} + 6 {H}^{+} {{⇄}_{{k}_{- 2}}}^{{k}_{2}} 3 {I}_{2} + 3 {H}_{2} O {K}_{2} = \frac{{k}_{- 2}}{{k}_{2}} \qquad ( 2 )$$

$${I}_{2} + {I}^{-} {{⇄}_{{k}_{- 3}}}^{{k}_{3}} {I}_{3}^{-} {K}_{3} = \frac{{k}_{- 3}}{{k}_{3}} \qquad ( 3 )$$

In the conventional two-fluid mixing mixer shown in FIG. 6, a first pipe PK1, which sends the first fluid F1, and a second pipe PK2, which sends the second fluid F2, are opposed to each other in a three-way block BL. The mixture of the first fluid F1 and the second fluid F2 in the three-way block BL is sent to a thin-walled, straight cylindrical third pipe PK3, which houses the elongated mixing element 42, and is mixed by the mixing element before being outputted as a third fluid F12. The third pipe PK3, which is constituted by a cylindrical metal pipe, has disadvantage of being easily deformed by the tightening of each joint CP, thereby causing problems when the mixing element 42 is to be inserted and removed. In addition, a distance or time from the junction of the first fluid F1 and the second fluid F2 to the start of mixing by the mixing element 42 is so long that a high mixing performance cannot be obtained, especially, at extremely a low flow rate of 5 mL/min or less in total flow rate, as described below.

### (Mixing Test Condition)

First fluid F1: HCl (concentration=0.0020 kmol/m³)
Second fluid F2: mixture of H₂BO₃ (concentration=0.045 kmol/m³), NaOH
(concentration=0.045 kmol/m³), KI (concentration=0.016 kmol/m³) and KIO₃
(concentration=0.0030 kmol/m³)
Quantitative pump: diaphragm pump reaction temperature: 293° K
Absorbance measurement: Analysis of UV absorbance (wavelength: 352 nm) of I3—when equal amounts of first fluid and second fluid are pumped

In FIG. 7, data points marked with ▪ indicate the absorbance when the conventional two-fluid mixing mixer of FIG. 6 was used, and data points marked with • indicate the absorbance when the mixer 10 of the present first embodiment was used. In a range in which the total flow rate of the mixer 10 (flow rate of the third fluid F12) is 5 mL/min or less, especially, in a range in which the total flow rate of the mixer 10 is 0.05 to 1 mL/min, the absorbance when using the mixer 10 of FIG. 1 in the present embodiment is lower than the absorbance when using the conventional two-fluid mixing mixer of FIG. 6, and a high mixing performance was obtained. Since the first fluid and the second fluid are reactive with each other, the first fluid F1 and the second fluid F2 are mixed immediately after joining, as shown in FIG. 5, so that a high mixing performance can be obtained in the mixer 10 of the present first embodiment.

### Second Embodiment

Hereinafter there will be described a mixer 60 of another embodiment of the present invention. In the following description, parts common to the above embodiment are designated by the same reference signs and description thereof will be omitted.

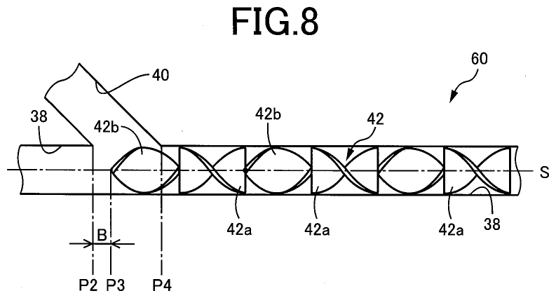

FIG. 8 is a view corresponding to FIG. 5, which is for explaining a main part of the mixer 60 of the present embodiment. The mixer 60 of the present embodiment is the same as the mixer 10 of the above-described first embodiment in that the upstream-side end portion of the mixing element 42 is located within the junction of the first and second passages 38, 40, namely, is located between the most upstream-side end P2 and the most downstream-side end P4 of the opening of the second passage 40 in the direction of the axis S, wherein the opening of the second passage 40 opens in the first passage 38.

However, the mixer 60 is different from the mixer 10 of FIG. 1 in which the upstream end P1 of the mixing element 42 is located on the upstream side of the junction point P2 in the direction of the axis S by the distance A that is about the half of the length of each of the clockwise twisted portions 42a or counterclockwise twisted portions 42b, wherein the junction point P2 is a point at which the second fluid F2 having passed through the second passage 40 is caused to join with the first fluid F1 passing through the first passage 38. In the mixer 60 of the present embodiment, an upstream end P3 of the mixing element 42 is located on the downstream side of the junction point P2 in the direction of the axis S by a distance B that is about the half of the length of each of the clockwise twisted portions 42a or counterclockwise twisted portions 42b,

### Experimental Example 2

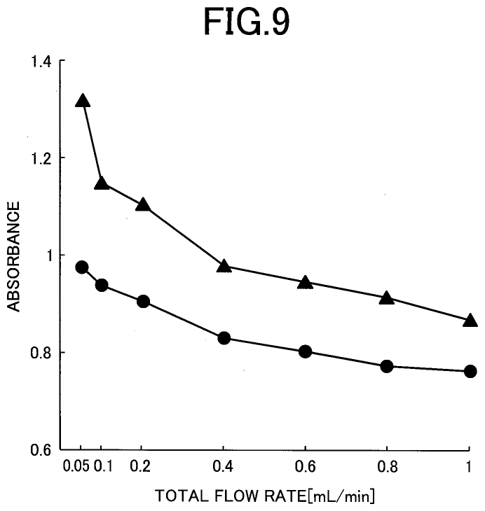

In this Experimental Example 2, the present inventors measured the absorbance of the mixer 60 using the above-described mixing ratio test condition and the Dushman reaction for the total flow rate ranging from 0.05 to 10 mL/min. In FIG. 7, the data points marked with ▴ indicate the absorbance when the mixer 60 of this second embodiment was used, as compared with the absorbance in each of the conventional mixer and the mixer 10. FIG. 9 shows the absorbance measured for the total flow rate (mL/min) in the mixer 10 of the first embodiment and the absorbance measured for the total flow rate (mL/min) in the mixer 60 of the second embodiment, in enlargement on its horizontal axis. The data points marked with ▴ show the absorbance when the mixer 60 of FIG. 5 was used, and the data points marked with • show the absorbance when the mixer 10 of the first embodiment shown in FIG. 1 was used.

As shown in FIG. 7, in the mixer 60, the first fluid F1 and the second fluid F2 are mixed immediately after joining, so that the absorbance at the total flow rate of 5 mL/min or less is lower than that in the conventional two-liquid fluid mixer of FIG. 6, and a high mixing performance was obtained.

As shown in FIG. 9, in the range of the total flow rate of 0.05-1.0 (mL/min), the absorbance in the mixer 10 is about 10-25% lower than that of the mixer 60, and the lower the total flow rate is in the range of 0.05-1.0 (mL/min), the larger the difference in absorbance. That is, the mixing performance of the mixer 10 is higher than that of the mixer 60, and the lower the total flow rate is in the range of 0.05-1.0 (mL/min), the larger the difference in the mixing performance. Because the first fluid and second fluid are reactive, it is considered that the shorter the time from the joining to the mixing, the higher the mixing performance.

As described above, in each of the mixers 10, 60 of the first and second embodiments, the first passage 38 is provided in the main body 18 to extend straightly between the first connection portion 20 and the third connection portion 24, the second passage 40 is provided in the main body 18 to branch from the first passage 38 to open in the second end surface 14, and the elongated mixing element 42 is housed in the first passage 38 and is positioned in contact with the third tube 34 that is connected to the third joint 36 screwed in the third connection portion 24. Thus, the elongated mixing element 42 is housed in the first passage 38 extending in a straight line, and is located in the main body 18 which is a thick, integral structure with high rigidity, and can be removed when it is to be cleaned, resulting in a high washability. Further, since the main body 18 can be constructed as an integral unit, there is no possibility of leakage of the third fluid (mixed fluid) F12, the number of components of each of the mixers 10, 60 is reduced, and the structure body is small. Further, since the elongated mixing element 42 is positioned by being in contact with the third tube 34 connected to the third joint 36 fixed to the third connection portion 24, there is no need to provide a stopper to prevent movement of the mixing element 42 having a relatively small diameter, which provides an advantage that, when the elongated mixing element 42 is to be cleaned, the elongated mixing element 42 can be removed without interference.

Further, in each of the mixers 10, 60 of the first and second embodiments, the upstream-side end portion of the mixing element 42 is located in the junction of the first and second passages 38, 40. That is, the upstream-side end portion of the mixing element 42 is located between the most upstream-side end P2 and the most downstream-side end P4 of the opening of the second passage 40 in the direction of the axis S, wherein the opening of the second passage 40 is an opening that opens in the first passage 38. Thus, the first fluid F1 introduced by the first passage 38 and the second fluid F2 introduced by the second passage 40 are joined with each other, and start to be mixed to each other by the mixing element 42 immediately after joining, so that a mixing performance can be achieved even with minute flow rates. Since the first fluid F1 and the second fluid F2 have property of reacting with each other to generate by-products, if there is a distance from the junction of the first and second passages 38, 40 to reach the mixing element 42, the by-products are generated during that time, so that, even if mixing by the mixing element 42 starts after that, it is difficult to obtain a sufficient mixing performance. This kind of inconvenience is more noticeable the smaller the flow rates of the first and second fluids F1, F2. However, if mixing by the mixing element 42 starts immediately after the first fluid F1 and the second fluid F2 join with each other, the mixing by the mixing element 42 starts before the by-products are generated, so that a high mixing performance can be obtained.

Further, in the mixer 10 of the first embodiment, the upstream end P1 of the mixing element 42 is located on the upstream side of the junction point P2 at which the second fluid F2 having passed through the second passage 40 is caused to join with the first fluid F1 passing through the first passage 38. Thus, as compared with a case (i.e., case of the mixer 60) in which the upstream end P1 of the mixing element 42 is located on the downstream side of the junction point P2, a further high mixing performance can be obtained even when the total flow rate is as low as 1 mL/min or less.

Further, in each of the mixers 10, 60 of the first and second embodiments, the main body 18 is constituted by a transparent thick plate-shaped member. Thus, the mixing state of the first and second fluids F1, F2 can be visually observed. Further, because the main body 18 is constructed as a single unit, there is no possibility of leakage of the mixed fluid, and a number of components required to constitute the micro-static mixer is reduced, so that the structure body is smaller.

Further, in each of the mixers 10, 60 of the first and second embodiments, the elongated mixing element 42 is constituted by the belt-shaped member, and includes the clockwise twisted portions 42a and the counterclockwise twisted portions 42b that are alternately arranged in the axial direction of the elongated mixing element 42, such that the belt-shaped member is twisted clockwise by 180 degrees around the axis of the elongated mixing element 42 in each of the clockwise twisted portions 42a, such that the belt-shaped member is twisted counterclockwise by 180 degrees around the axis in each of the counterclockwise twisted portions 42b, and such that the linear edge Ea constituted by the end of each of the clockwise twisted portions 42a in the axial direction is perpendicular to the linear edge Eb constituted by the end of each of the counterclockwise twisted portions 42b in the axial direction, which is adjacent to the linear edge Ea constituted by the end of each of the clockwise twisted portions 42a in the axial direction. Thus, the first and second fluids F1, F2 having joined with each other in the first passage 38 are efficiently mixed with each other by the elongated mixing element 42 housed in the first passage 38.

Further, in each of the mixers 10, 60 of the first and second embodiments, the third tube 34, which is connected to the third joint 36 screwed in the third connection portion 24, is reduced in diameter by the third joint 36, and the elongated mixing element 42 is positioned in contact with the end face of the third tube 34 that is reduced in the diameter. Thus, it is not necessary to provide, in the main body 18, a stopper for positioning the mixing element 42, and it is possible to increase a degree of freedom to remove the mixing element 42 when the mixing element 42 is to be cleaned

While the preferred embodiments of the present invention have been described above in detail by reference to the drawings, it is to be understood that the invention may be carried out in various forms with various modifications and improvements based on knowledge of those skilled in the art.

For example, in the first and second embodiments, the reactive first fluid F1 is constituted by the HCl solution by way of example, and the reactive second fluid F2 is constituted by the mixture of H₂BO₃, NaOH, KI and KIO₃ by way of example. However, the first fluid F1 and the second fluid F2 may be mutually unreactive, or may be other types of solutions (reagents) that react with each other to generate by-products. In the latter case, where they are mixed immediately after joining, the generation of the by-products is suppressed and a high mixing rate can be obtained.

### DESCRIPTION OF REFERENCE SIGNS

10: mixer (micro-static mixer)
12: first end surface
14: second end surface
16: third end surface
18: main body
20: first connection portion
22: second connection portion
24: third connection portion
24t: tapered inner circumferential surface
26: first tube
28: first joint
30: second tube
32: second joint
34: third tube
36: third joint
38: first passage
40: second passage
42: mixing element
42a: clockwise twisted portion
42b: counterclockwise twisted portion
46: center hole
48: operating portion
50: external thread portion
52: tapered portion
60: mixer 60 in which upstream end P3 of mixing element is located on downstream side of junction point P2
Ea: linear edge of clockwise twisted portion
Eb: linear edge of counterclockwise twisted portion
P1: upstream end of mixing element (in case in which upstream end is located on upstream side of junction point P2)
P2: junction point
P3: upstream end of mixing element (in case in which upstream end is located on downstream side of junction point P2)

1. A micro-static mixer for mixing two fluids, the micro-static mixer comprising:
a main body having a first end surface, a second end surface and a third end surface such that the first and third end surfaces are opposed to each other;
a first joint screwed in a first connection portion of the first end surface;
a second joint screwed in a second connection portion of the second end surface;
a third joint screwed in a third connection portion of the third end surface;
a first tube connected to the first joint, such that a first fluid is to be inputted through the first tube;
a second tube connected to the second joint, such that a second fluid is to be inputted through the second tube;
a third tube connected to the third joint, such that a third fluid that is a mixture of the first and second fluids is to be outputted through the third tube;
a first passage provided in the main body and extending straightly to connect between the first connection portion and the third connection portion;
a second passage provided in the main body and branching from the first passage to open in the second end surface; and
an elongated mixing element housed in the first passage,
wherein the elongated mixing element is positioned in contact with the third tube that is connected to the third joint screwed in the third connection portion.

2. The micro-static mixer according to claim 1,
wherein the elongated mixing element has an upstream-side end portion that is located in a junction of the first and second passages.

3. The micro-static mixer according to claim 1,
wherein the elongated mixing element has an upstream end that is located on an upstream side of a junction point at which the second fluid having passed through the second passage is caused to join with the first fluid passing through the first passage.

4. The micro-static mixer according to claim 1,
wherein the main body is constituted by a transparent thick plate-shaped member.

5. The micro-static mixer according to claim 1,
wherein the elongated mixing element is constituted by a belt-shaped member, and includes clockwise twisted portions and counterclockwise twisted portions that are alternately arranged in an axial direction of the elongated mixing element, such that the belt-shaped member is twisted clockwise by 180 degrees around an axis of the elongated mixing element in each of the clockwise twisted portions, such that the belt-shaped member is twisted counterclockwise by 180 degrees around the axis in each of the counterclockwise twisted portions, and such that a linear edge constituted by an end of each of the clockwise twisted portions in the axial direction is perpendicular to a linear edge constituted by an end of each of the counterclockwise twisted portions in the axial direction.

6. The micro-static mixer according to claim 1,
wherein the third tube, which is connected to the third joint screwed in the third connection portion, is reduced in diameter by the third joint, and the elongated mixing element is positioned in contact with an end face of the third tube that is reduced in the diameter.
